(19) United States
(12) Patent Application Publication
(10) Pub. No.: US 2026/0236509 A1
(43) Pub. Date: Aug. 13, 2026

(54) SEARCHING PATENT DOCUMENTS

(71) Applicant: Legalicity Ltd., Toronto (CA)

(72) Inventors: James STONEHILL, London (GB); Dario BERTERO, London (GB)

(21) Appl. No.: 19/448,697

(22) Filed: Jan. 14, 2026

Related U.S. Application Data
(60) Provisional application No. 63/755,476, filed on Feb. 7, 2025.

(51) Int. Cl. G06F 16/334

(52) U.S. Cl. CPC G06F 16/3347

(57) ABSTRACT

Methods and systems for identifying patent documents similar to a search query comprising natural language content. First similarity values between the natural language content of the search query and patent documents are determined by comparing a query vector embedding determined from the natural language content of the search query using an embedding machine learning model to document vector embeddings determined from respective patent documents of the set. The document vector embedding is a weighted average of separate vector embeddings of the natural language content of a set of one or more claims and of one or more other sections of that patent document, each determined using the embedding model. A first subset of the set of patent documents, including patent documents with first similarity values above a first similarity threshold is selected and a second similarity value between the natural language content of the search query and each of the first subset of patent documents is determined using a cross-encoder machine learning model. A second subset of the first subset of patent documents with second similarity values above a second similarity threshold is identified.

### CROSS-REFERENCE TO RELATED APPLICATIONS

The present invention claims the benefit of U.S. Provisional Patent Application No. 63/755,476, filed Feb. 7, 2025, which is incorporated by reference herein in its entirety.

### FIELD OF THE INVENTION

The present application relates to methods and systems for searching patent documents, in particular to methods and systems using machine learning models for identifying patent documents similar to a search query including natural language content.

### BACKGROUND TO THE INVENTION

Patent searching may be performed for a variety of reasons, such as to assess whether new inventions are potentially novel and patentable, to determine whether a concept is already patented as part of a freedom-to-operate assessment, to identify prior art to invalidate a competitor's patent or patent application, as part of a patent watch or monitoring survey, as part of a due-diligence assessment of a patent's validity, or when conducting patent landscaping of a particular field.

However, searching for patents or patent applications relevant to a particular query typically involves searching a very large number of documents written in technical language or jargon. It is typically performed by professional patent searchers and search results can rapidly become out of date due to ongoing publication of new patent applications.

Patent searching is therefore often difficult, time consuming, and expensive, without providing any legal guarantees.

An aim of the present invention is to address the difficulties outlined above and provide improved methods and systems for searching patent documents.

### SUMMARY OF THE INVENTION

According to a first aspect of the invention, there is provided a method for identifying patent documents similar to a search query, the search query comprising natural language content, the method comprising: determining first similarity values between the natural language content of the search query and patent documents of a set of patent documents by comparing a query vector embedding determined from the natural language content of the search query using an embedding machine learning model to document vector embeddings determined from respective patent documents of the set, wherein the document vector embedding determined from a respective patent document of the set is a weighted average produced by a learned weighted sum of separate vector embeddings of the natural language content of a set of one or more claims and of one or more other sections of that patent document, each determined using the embedding machine learning model, the weights being trainable parameters; selecting a first subset of the set of patent documents including patent documents with first similarity values above a first similarity threshold; determining a second similarity value between the natural language content of the search query and each of the first subset of patent documents using a cross-encoder machine learning model; and identifying a second subset of the first subset of patent documents with second similarity values above a second similarity threshold.

Unlike many other types of documents which can be searched using machine learning systems, patent documents have a defined structure with a plurality of sections that each separately describe the same subject matter, with varying levels of details and generality. Specifically, a published patent document—which may be a patent application or a granted patent—includes at least a title, an abstract, a description and a set of claims. The title names an invention covered by the patent document, the abstract briefly describes the most important elements of the invention; the description describes the invention in much greater detail, typically with reference to a set of accompanying figures, including discussion of optional or alternative features and advantages that the invention provides; and the claims define the legal scope of protection sought (and in the case of a granted patent, that scope which has been deemed allowable by an Examiner). The claims are typically more precise and include at least the elements or steps required to practice the invention. As the claims must meet inter alia the requirements of novelty and inventive step (or unobviousness), the claims will thus capture at least those elements which distinguish the invention described in the patent document from the prior art.

Embodiments described herein use an embedding model to derive separate vector embeddings of the natural language content of at least a patent document's set of claims and of one or more other sections thereof (such as its description, abstract and/or title), and then calculate a weighted average of these vectors to obtain an overall document vector embedding for that patent document. In some embodiments, separate vector embeddings of the patent document's title, abstract, description and set of claims may be derived and a weighted average thereof may be calculated to obtain the overall document vector embedding for that patent document, such a document vector embedding can more accurately reflect the invention described in the patent document, for example, by providing a greater weighting to the abstract and/or claims whose natural language content more specifically focusses on the unique aspects of an invention that is the subject of the patent document.

In training, the document vector embedding for a patent document is formed as a weighted sum of section embeddings of the claims, abstract, description and optionally title, where the weights are trainable parameters. The embedding model and the section weights are jointly optimized via backpropagation to minimize a loss that penalizes divergence between calculated pairwise similarities and patent-specific similarity labels. Patent-specific labels are derived from a fusion of CPC/IPC proximity metrics (for example, shared subclasses or shortest-path distances in the classification hierarchy) and citation-derived signals (for example, forward and backward examiner citations appearing in office actions), optionally with jurisdictional normalization. The loss can be implemented as mean squared error or a margin-based contrastive loss, and optimization may employ AdamW with a weight decay in the range of 1e−4 to 1e−2.

The similarities of these document vector embeddings to a query vector embedding are determined using vector distance calculations such as cosine similarity and are used to identify and select the first subset of the set of patent documents, and a more computationally intensive cross-encoder model may then be used to determine more accurate second similarity values for the more limited first subset of documents by comparing patent documents to the natural language content of the search query, thereby completing a search reranking operation. A second more limited subset of the first subset of documents is then selected.

In some embodiments, first similarity values may be determined between the natural language content of the search query and each of the set of patent documents. Document vector embeddings may be derived from each of the set of patent documents as described above. Alternatively, first similarity values may only be determined between the natural language content and some of the set of patent documents, in combination with other vector search techniques such as using one or more pre-constructed vector graphs (for example, a Hierarchical Navigable Small World (HNSW) graph) to identify the first subset of the set of patent documents with first similarity values above a first similarity threshold.

The search query comprises natural language content. The natural language content of the search query may comprise a natural language passage and/or one or more selected patent documents. The natural language content of the search query may be used to specify a concept to be searched, by describing the subject matter directly in a natural language passage and/or by specifying patent documents covering the concept, elements thereof, or closely related technologies.

In some embodiments, the natural language content of the search query includes a natural language passage. The natural language passage of the search query may be a written description of an invention, such as a user input description of an invention. A user may thereby use the search query to search for patent documents describing the concept, either with a view to assessing its novelty—and by extension patentability—before potentially filing a patent application for it, or with a view to assessing whether the concept is covered by any granted or pending patent applications, as part of a freedom to operate assessment. In such embodiments, deriving the query vector embedding comprises deriving a vector embedding of the natural language passage using the embedding machine learning model.

Alternatively, or additionally, the natural language content of the search query may comprise one or more selected patent documents. Such a query may be used to monitor a technical field of an existing patent or patent application, or may be used to supplement a natural language passage as described above, for example by including previously identified patent documents that a user believes are related to a concept to be searched, for example, documents identified in a previous search, or the user's own patent documents for an earlier related invention.

In embodiments where the natural language content of the search query comprises one or more selected patent documents, the query vector embedding may be derived from document vector embeddings for each of the one or more selected patent documents. If the search query comprises a plurality of selected patent documents, the query vector embedding may be derived from an average of the document vector embeddings for the plurality of selected patent documents. In some embodiments, such an average may be weighted, for example, according to relative importance scores assigned to the selected patent documents by a user in the search query.

Document vector embeddings of the selected patent documents may be derived using the embedding machine learning model in the same manner as the document vector embeddings of the set of patent documents, i.e. by deriving separate vector embeddings of the natural language content of at least a description, and a set of one or more claims of that selected patent document and calculating a weighted average of the separate vector embeddings to obtain the vector embedding for that selected patent document. In some embodiments, the selected patent documents may be part of the set of patent documents.

In some embodiments, the document vector embeddings for the selected patent documents may be retrieved from a database storing pre-derived document vector embeddings for each of the set of patent documents when calculating the query vector embedding. Alternatively, the document vector embeddings for the selected patent documents may be derived by the embedding machine learning model when calculating the query vector embedding. The term patent documents may refer to published patents, published patent applications, and/or translations thereof.

In some embodiments, the search query may comprise both a natural language passage and one or more selected patent documents, and the query vector may be derived from a vector embedding of the natural language passage and from document vector embeddings for each of the selected patent documents. In some such embodiments, the query vector embedding may be an average of the vector embedding of the natural language passage and of document vector embeddings for the one or more selected patent documents. In some such embodiments, the query vector may be an average of a vector embedding of the natural language passage and of an average of the document vector embeddings for each of the selected patent documents. The averages may be weighted. This may allow the query vector to represent a combination of the subject matter described in the natural language passage and of the one or more selected patent documents.

In some embodiment, the embedding model is section-aware. Each input includes a section-type indicator token (for example, [CLAIMS], [ABSTRACT], [DESCRIPTION], [TITLE]) prepended to the text and/or a section-specific positional embedding. This conditioning causes the encoder to learn distinct representations per section and improves downstream weighting in the learned weighted sum.

In some embodiments, the natural language query may be accompanied by filter criteria that filter the set of patents against which the vector search is performed. For example, the filter criteria may comprise one or more bibliographic criteria, which may include filing date criteria, publication date criteria, expiration date criteria, priority claim criteria, applicant criteria, assignee criteria, licensee criteria, current owner criteria, CPC and/or IPC classification criteria, inventor criteria, jurisdiction criteria, and/or legal status criteria (such as whether the patent document relates to a patent application or a granted patent, and/or whether the patent document relates to a lapsed patent or patent application, or to one that is still pending or in force). In some embodiments, the filter criteria may comprise logical relationships between different bibliographic criteria, such as AND, OR, NOR, NAND, XOR, or XNOR relationships. Date criteria may comprise ranges of included and/or excluded dates.

When bibliographic criteria are present, the system determines a proportion p of the corpus satisfying the criteria and compares p against a threshold. If p≥τ (for example, τ=0.9), a preconstructed approximate nearest neighbor graph index over the entire corpus (for example, a Hierarchical Navigable Small World (HNSW) graph) is used to compute first similarity values, and the bibliographic filters are applied post hoc. If p<τ, the corpus is prefiltered to form a reduced sub-corpus satisfying the bibliographic criteria and an approximate nearest neighbor graph index over the sub-corpus is used. This decision policy improves latency without degrading recall in patent corpora by reusing global graph structures when filters would otherwise capture most of the corpus.

In such embodiments, the method may comprise filtering an initial collection or superset of patent documents to identify the patent documents therein that satisfy the one or more bibliographic criteria.

In some embodiments, the identified patent documents that satisfy the one or more bibliographic criteria may be selected as the set of patent documents. The set of patent documents may therefore be a subset of the larger initial collection of patent documents that satisfy the bibliographic criteria.

Alternatively, the method may comprise initially determining a proportion of an initial collection or superset of patent documents that satisfy the one or more bibliographic criteria and, if less than a threshold proportion (such as less than 90%) of the initial collection satisfy the one or more bibliographic criteria selecting the patent documents that satisfy the one or more bibliographic criteria as the set of patent documents, and if at least the threshold proportion of the initial collection satisfy the one or more bibliographic criteria selecting the entire initial collection as the set of patent documents. Therefore, the initial collection is only filtered if doing so will reduce the number of patent documents to be searched to less than the threshold proportion. This may advantageously allow pre-constructed vector graphs, such as Hierarchical Navigable Small World (HNSW) graphs, for the entire initial collection of patent documents to be used to optimise the searching thereof instead of filtering the initial collection according to the bibliographic criteria. In such situations, the performance benefits of the pre-constructed vector graph may outweigh the performance cost of searching the additional documents that do not satisfy the bibliographic criteria and then subsequently filtering these additional documents out of the result set.

In some embodiments, the method may comprise filtering the documents determined to have first similarity values above the first similarity threshold to obtain those documents which both satisfy the bibliographic criteria, and which have first similarity values above the first similarity threshold and selecting said documents as the first subset, for example after using a pre-constructed vector graph instead of initially filtering the patent documents as discussed above.

In some embodiments, the method may comprise obtaining the search query. The search query may be obtained by being input by a user, by being received from another system, and/or by being loaded from a memory.

In some embodiments, the method comprises either receiving the search query from user inputs and saving the search query to a computer memory or loading the search query from the computer memory. In such embodiments, when a search query is first input by a user it is saved and subsequently can be loaded to enable another instance of the previously performed search to be run to obtain updated search results accounting for newly published patent documents and/or updates to the embedding and/or cross-encoder machine learning models.

In some embodiments, the method may comprise automatically loading a search query from a memory and performing the search based on an amount of time that has lapsed since a search using that query was last performed. This may enable a search query to be performed periodically, for example, as part of regular monitoring. The amount of time may be a user-selected duration associated with the search query. A monitor database may store monitors comprising search queries and associated frequencies, and a scheduler may periodically check for and schedule overdue monitors.

In embodiments in which the search query comprises one or more selected patent documents, the selected patent documents may be specified by identifying numbers, such as their publication numbers. The method may then comprise retrieving pre-derived document embedding vectors for the selected patent documents from a database in order to derive the query vector embedding.

In some embodiments, the method comprises deriving the query vector embedding from the natural language content of the search query. This may involve using the embedding machine learning model to derive vector embeddings of a natural language passage thereof. Alternatively, or additionally, it may involve calculating or retrieving document vector embeddings of one or more selected patent documents which in turn are weighted averages of separate vector embeddings of parts of said documents derived using the embedding model.

In training, the document vector embedding for a patent document is formed as a weighted sum of section embeddings of the claims, abstract, description and optionally title, where the weights are trainable parameters. The embedding model and the section weights are jointly optimized via backpropagation to minimize a loss that penalizes divergence between calculated pairwise similarities and patent-specific similarity labels. Patent-specific labels are derived from a fusion of CPC/IPC proximity metrics (for example, shared subclasses or shortest-path distances in the classification hierarchy) and citation-derived signals (for example, forward and backward examiner citations appearing in office actions), optionally with jurisdictional normalization. The loss can be implemented as mean squared error or a margin-based contrastive loss, and optimization may employ AdamW with a weight decay in the range of 1e−4 to 1e−2. In some embodiments, weights may be constrained (for example, non-negative and summing to one) via regularization during training.

The embedding machine learning model is configured to receive a sequence of text as an input and to produce a vector as an output. The output vector embeds the semantic meaning of the input text sequence and is referred to as a vector embedding thereof.

The embedding model is used in a variant of a bi-encoder model arrangement, in which the same embedding model is used to independently derive embedding vectors from two different inputs (the natural language content search query and a patent document) and a measurement of the similarity of the inputs is determined by calculating a similarity of the two embedding vectors.

Bi-encoder models are particularly effective at identifying members of a large dataset (such as a set of published patent documents) that are similar to a search query, as vector embeddings of members of the dataset can be derived in advance, and the calculation of the similarities between the vector embeddings is a fast computationally efficient process. However, they may be less sensitive to particular relationships between inputs being compared than more computationally intensive models that process both inputs together thereby making use of the model's cross-attention, such as cross-encoder machine learning models.

The variant bi-encoder arrangement employed by the invention differs from conventional bi-encoder arrangements in at least that the vector embedding derived from the patent document is not a direct vector embedding of the text of the patent document. Instead, it is a weighted average of a vector embedding of the patent document's abstract, a vector embedding of the patent document's description, and a vector embedding of the patent document's set of claims. If the search query includes one or more selected patent documents, the query vector embedding may also be derived using such an average.

The embedding model may be any deep learning based embedding model, such as a trained instance of a transformer-based language model such as BERT (Bidirectional Encoder Representations from Transformers) or a variant thereof, such as sBERT or RoBERTa. Such models may comprise an initial tokenizer and a series of bidirectional self attention layers feed-forward transformation layers.

The embedding model may be trained or fine-tuned using patent document training data to adjust its weights. This may allow the weights to be optimised for patent language/vocabulary. Such patent document training data may include patent documents with similarity metrics between pairs of patent documents based on the proximity or overlap between international patent classification (IPC) codes and/or cooperative patent classification (CPC) codes of the two documents and/or on any citations of an earlier of the two patent documents against the later of the two patent documents for the purposes of novelty or inventive step in any search reports, examination reports, or other office actions for the latter patent document. Training or fine tuning of the embedding model may comprise deriving document vector embeddings for pairs of patent documents in the training data using the embedding model, calculating a similarity therebetween, and comparing the calculated similarity to the similarity metric in the training data to determine a loss therebetween. Weights of the embedding model may then be updated based on losses via backpropagation. In such training the derived document vector embeddings may be derived as described above, as a weighted average of separate abstract, description and claim vector embeddings. In some such embodiments, the weights of the weightings of the various separate vector embeddings in the weighted sum may also be updated based on the losses via backpropagation. In one implementation, the encoder comprises 12-24 transformer layers with hidden sizes between 768 and 1024, and maximum input tokens per section between 512 and 2048.

The method comprises determining first similarity values between the natural language content of the search query and patent documents of a set of patent documents by comparing a query vector embedding determined from the natural language content of the search query using the embedding machine learning model to document vector embeddings derived from patent documents of the set.

As described above, in some embodiments, first similarity values may be determined between the natural language content of the search query and each of the set of patent documents. Document vector embeddings may be derived from each of the set of patent documents as described above.

Alternatively, first similarity values may only be determined between the natural language content and some of the set of patent documents. This may be used in combination with other vector search techniques such as using one or more pre-constructed vector graphs (for example, a Hierarchical Navigable Small World (HNSW) graph) for the set of patent documents, in order to identify the first subset of the set of patent documents with first similarity values above a first similarity threshold.

In some embodiments, determining the first similarity value between the natural language content of the search query and patent documents may comprise calculating the cosine similarity between the query vector embedding and document vector embeddings determined from said patent documents. The first similarity value may be the cosine similarity. Alternatively, an alternative similarity metric such as simply the dot product of the vector embeddings may be used, or a normalized L2 distance may be used

In some embodiments, the method may comprise retrieving pre-calculated document vector embeddings for some or each of the set of patent documents, for example from a database or computer memory. The database or memory storing the document vector embeddings may be updated periodically to add document vector embeddings for newly published patent documents and/or to update the document vector embeddings following any update to the embedding model.

The set of patent documents for which first similarity values are calculated (and/or for which document vector embeddings are retrieved) may be a selected set of documents from a larger collection of patent documents whose document vector embeddings may be stored in the database or computer memory. For example, the set of patent documents may be the patent documents in the larger collection that satisfy any bibliographic criteria comprised by the search query.

In some embodiments, the set of patent documents may only comprise an individual patent document from each family of patent documents in the larger collection that share a priority claim. Only including individual patent documents from families of patent documents with shared priority claims may reduce the size of the set of patent documents by avoiding the inclusion of multiple patent documents duplicating the same subject matter. The individual patent document of each family that is included in the set may be selected from the patent family based on its language, jurisdiction and/or filing date. For example, if a patent family includes one or more United States patents or patent applications, the individual patent document of a patent family that is included in the set may be a United States patent document. Selection may be based on a composite score combining language availability, jurisdiction priority, claim clarity, and translation quality when applicable.

In alternative embodiments, the collection of patent documents whose document vector embeddings are pre-derived and stored in the database or computer memory may only comprise an individual patent document from each family of patent documents in the larger collection that share a priority claim. Such an individual patent document may be selected in the same manner as described above.

The document vector embeddings for a patent document of the set is a weighted average of separate vector embeddings of the natural language content of at least a set of one or more claims and of one or more other sections of that patent document determined using the embedding model. The vector embeddings of the natural language content of the one or more other sections may comprise a separate vector embedding of a description of the patent document, a separate vector embedding of a title of the patent document, and/or a separate vector embedding of an abstract of the patent document.

In some embodiments, the set of patent documents may comprise translations, such as machine translations, of patent documents which are not in a chosen language, such as English. For example, the set of patent documents may comprise translations of patent documents in a larger collection of patent documents that are not in the chosen language. Alternatively, the set of patent documents may comprise a translation of an individual patent document from each family of patent documents in the larger collection that share a priority claim but which do not include a patent document in the chosen language. In such embodiments, the set of patent documents may not include any patent documents which are not in the chosen language.

Translations are included only if there is no English official translation of the publication, but we do not take into account if there are other family members that have official versions in English as there may be relevant differences in the specs across family members., and inclusion is gated by a translation quality score satisfying a threshold (for example, COMET≥0.75). Otherwise, the method selects the best available original-language representative or excludes the translation from section embedding formation.

The weightings of the various separate vector embeddings in the weighted sum may be determined using a machine learning training process. This training may be performed along with training of the embedding model itself. During training the weights may be updated via backpropagation based on a losses between similarity metrics between pairs of patent documents in a training data set, and calculated similarities therebetween based on document vector embeddings derived using the embedding model and initial weightings of the weighted sum, The similarity metrics between pairs of patent documents in the training data may be based on the proximity or overlap between international patent classification (IPC) codes and/or cooperative patent classification (CPC) codes of the two documents and/or on any citations of an earlier of the two patent documents against the later of the two patent documents for the purposes of novelty or inventive step in any search reports, examination reports, or other office actions for the latter patent document.

In embodiments, the document vector embedding of each patent document is a weighted average of vector embeddings of the description, set of claims, and one or more other sections of the patent document, such as vector embeddings of the document's abstract and/or title, a separate ‘summary of the invention’ section, and/or a ‘background’ section derived using the embedding model, or of one or more figures of the application derived using a separate model.

The method comprises selecting a first subset of the set of patent documents with first similarity values above a first similarity threshold.

While the determined first similarity values allow the set of patent documents to be ranked according to their semantic similarity to the search query, as calculated using the bi-encoder arrangement described above, the accuracy of these similarity scores is limited because the patent documents and search query are encoded into vectors separately, so cannot capture detailed interactions between the query and patent documents. Therefore, the bi-encoder arrangement's ability to differentiate the most similar documents is limited. Selecting only on the most similar patent documents with similarity values above the first similarity threshold allows the slower and more computationally intensive cross-encoder to be used to ‘re-rank’ the search results to better reflect the similarity of the subject matter therein, while limiting the number of documents whose similarities need to be determined using the slower more computationally intensive cross-encoder.

The first subset of patent documents may be referred to as candidate patent documents.

In some embodiments, the first similarity threshold may be dependent on the determined first similarity values, or an upper range thereof, such as the top one hundred determined first similarity values. The method may comprise determining the first similarity threshold from the determined first similarity values, or the upper range thereof. In some embodiments, the first similarity threshold may be a fixed percentile (such as the fiftieth percentile) of an upper range of the determined first similarity values. For example, the first similarity threshold may be determined by selecting the fiftieth percentile of the range of first similarity values present for the top one hundred most similar patent documents. Therefore in situations where the similarity values are not uniformly distributed, such as where a relatively small number of most similar values are close together and separated from a remainder of very low values, the threshold may be applied between said groupings.

The first similarity threshold is determined adaptively from the distribution of the top-k first similarity values. In one implementation, the threshold is set to a percentile within the top-k values selected based on a dispersion statistic such as interquartile range (IQR), median absolute deviation (MAD), or a variance estimate. When the top-k distribution is multimodal, a knee-point heuristic combined with IQR places the threshold between modes to preferentially include tightly clustered high-similarity candidates.

After selecting the first subset, the method comprises determining a second similarity value between the natural language content of the search query and each of the first subset of patent documents using a cross-encoder machine learning model.

A cross-encoder machine learning model is a natural language machine learning model configured to receive two text sequences as inputs and to output a value indicating the similarity between the two text sequences.

The cross-encoder machine learning model may be a trained instance of a transformer-based language model such as BERT (Bidirectional Encoder Representations from Transformers) or a variant thereof, such as sBERT or RoBERTa. Such models may comprise an initial tokenizer and a series of bidirectional self-attention feed-forward transformation layers.

Determining a second similarity value between the natural language content of the search query and a candidate patent document comprises concatenating the search query text and at least a portion of the candidate patent document (for example, its claims section or claims plus abstract), separated by a special separator token (for example, [SEP]) in a transformer-based cross-encoder. The model outputs a scalar similarity score for each candidate.

If the natural language content of the search query comprises both a natural language passage and one or more patent documents, and/or a plurality of patent documents, determining the second similarity value between the natural language content of the search query and a patent document of the first subset may comprise concatenating the natural language passage and/or the one or more patent documents together, along with the patent document of the first subset.

The cross-encoder model may be trained or fine-tuned using patent document training data to adjust its weights. Such patent document training data may include patent documents with similarity metrics between pairs of patent documents based on the proximity or overlap between international patent classification (IPC) codes and/or cooperative patent classification (CPC) codes of the two documents and/or on any citations of an earlier of the two patent documents against the later of the two patent documents for the purposes of novelty or inventive step in any search reports, examination reports, or other office actions for the latter patent document. Training or fine tuning of the cross-encoder model may comprise deriving similarity values between pairs of patent documents in the training data and comparing the calculated similarity values to pre-determined similarity metrics in the training data to determine a loss therebetween. Weights of the cross-encoder model may then be updated based on losses via backpropagation.

In some embodiments, the method comprises determining a plurality of cross-encoder similarity values between the natural language content of the search query and each of the first subset of patent documents using a plurality of cross-encoder machine learning models. The plurality of different cross-encoder models may be trained from different base models and/or may be trained suing different similarity metrics between pairs of patent documents in the training data (for example one cross-encoder model may use training data with similarity metrics based on citations and another may use training data with similarity metrics based on IPC codes).

In some embodiments, a candidate is retained only if a consensus criterion is met across multiple cross-encoder outputs. For example, the relative difference between the maximum and minimum scores may be bounded by a percentage δ (for example, δ=10%), or the score variance may be below a threshold (for example, σ²≤0.02), indicating agreement across models trained on different label sets.

In such embodiments, the method may comprise determining the second similarity value from the plurality of cross-encoder similarity values, for example by taking the mean or median of the plurality of cross-encoder similarity values, taking the highest of lowest cross-encoder similarity value or otherwise aggregating the plurality of cross-encoder similarity values. In some embodiments, whether the plurality of cross-encoder similarity values determined using the different cross-encoder models have reached a consensus may be determined, for example, by comparing a percentage difference between the highest and lowest similarity values to a percentage threshold. Using multiple cross-encoder models in this manner may increase the reliability with which the second similarity values are determined.

The method comprises identifying a second subset of the first subset of patent documents with second similarity values above a second similarity threshold.

The second subset of patent documents are those that are particularly relevant to the search query, having been identified as above threshold similarity levels by both the bi-encoder and cross-encoder machine learning model configurations.

In some embodiments, the second similarity threshold may be user selected. Alternatively, the second similarity threshold may be derived from the second similarity threshold values.

In embodiments in which a plurality of second similarity values are determined for each of the first subset of patent documents using a plurality of cross-encoder models, the second subset may be a second subset of the first subset of patent documents which second similarity values that are all above the second similarity threshold.

In some embodiments, the method may comprise outputting a list of the second subset of patent documents and/or details of said patent documents. Outputting this information may comprise displaying the information, saving the information to a computer memory, exporting a file comprising the information and/or transmitting the information to a separate device. In some embodiments, a list of the second subset of patent documents and details thereof may be displayed using a user interface, which may be configured to enable a user to review details of the second subset of patent documents, their determined second similarity values, and/or to mark individual documents in the second subset of patent documents as particularly relevant or irrelevant.

In some embodiments, the method further comprises using a large language machine learning model to generate a natural language description of a degree of similarity between the natural language content of the search query and each of the second subset of patent documents. The large language model may be a generative transformer, which may be fine-tuned using pairs of search queries and documents to output a similarity evaluation and explanation of similarities and differences.

In some embodiments, the large language machine learning model that generates the natural language descriptions is a separate machine learning model to the embedding model and the one or more cross-encoder models. In alternative embodiment, the large language model may be the cross-encoder machine learning model (or one of the plurality of cross-encoder models) further configured and trained to generate such a natural language description.

The natural language description of the degree of similarity to a given one of the second subset of patent documents may inform a user of what features are in common between the search query and that patent document and what differences exist therebetween. This may facilitate a user in reviewing the second subset of patent documents defining the final search results to determine the relevance of the patent documents.

The natural language descriptions may be output and/or displayed in a user interface as described above.

According to a second aspect of the invention there is provided a system for identifying patent documents similar to a search query, the system comprising: one or more processors, and one or more computer readable storage devices, the one or more storage devices storing computer instructions which when implemented cause the one or more processors to: determine first similarity values between the natural language content of the search query and patent documents of a set of patent documents by comparing a query vector embedding determined from the natural language content of the search query using an embedding machine learning model to document vector embeddings determined from respective patent documents of the set, wherein the document vector embedding determined from a respective patent document is a weighted average of separate vector embeddings of the natural language content of at least a description, and a set of one or more claims of that patent document determined using the embedding model; select a first subset of the set of patent documents with first similarity values above a first similarity threshold; determine a second similarity value between the natural language content of the search query and each of the first subset of patent documents using a cross-encoder machine learning model; and
identify a second subset of the first subset of patent documents with second similarity values above a second similarity threshold.

In some embodiments, the one or more computer readable storage devices may further store document embeddings of the set of patent documents, or of a larger collection of patent documents from which the set of patent documents is selected.

The computer instructions may cause the processors to perform any of the optional steps described above with reference to the first aspect of the invention, and the system may comprise any optional features described above with reference to the first aspect of the invention.

### BRIEF DESCRIPTION OF THE FIGURES

Exemplary embodiments of the invention will now be described in detail with reference to the accompanying figures, in which:

FIG. 1a shows the operation of a system for identifying patent documents similar to a search query;

FIG. 1b shows the derivation of a document vector embedding for a patent document in the system of FIG. 1a in detail;

FIG. 2 shows an example of a search being performed for a search query describing a lithium ion battery; and

FIG. 3 shows the operation of a system for routinely monitoring one or more search queries. FIG. 4 is a flowchart illustrating a decision policy for selecting between a full-corpus approximate nearest neighbor graph index and a reduced sub-corpus index based on a computed proportion of documents satisfying bibliographic criteria, followed by adaptive first-subset selection and cross-encoder reranking.

### DETAILED DESCRIPTION OF THE FIGURES

Referring to the figures generally, there are shown examples of systems and methods for searching for patent documents similar to a query containing natural language content.

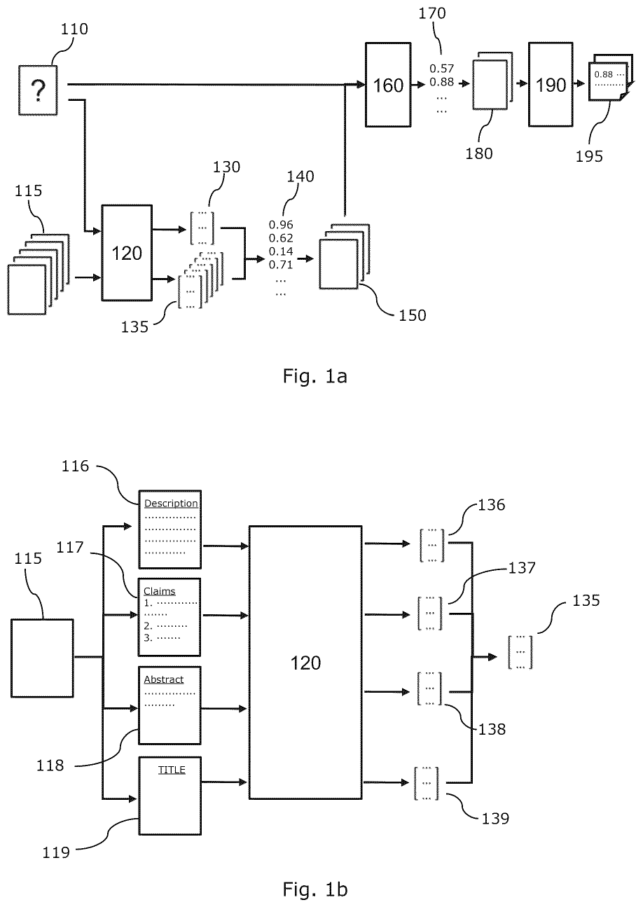

FIGS. 1a and 1b show the operation of a system configured to perform an embodiment of a method for identifying members of a set of patent documents 115 that relate to similar subject matter to a search query 110 using a search re-ranking operation.

FIG. 1a shows the overall operation of the system. In a first stage, the system uses an embedding model 120 in a bi-encoder configuration to determine a first similarity value 140 between each patent document 115 and the search query 110 and to identify a first subset 150 of the set of patent documents 115 that have more than a threshold level of similarity. In a second stage, the system uses a more computationally intensive cross-encoder model 160 to determine second similarity values 170 between each of the first subset 150 of patent documents and the search query 110, and select a second subset 180 of the first subset 150 of patent documents that are the most similar to the search query 110.

The search is performed on a search query 110, which may be a newly configured search query input to the system by a user, or a pre-established search query retrieved from a memory to be re-run, for example as part of an automatic monitoring process.

The search query 110 a natural language passage describing the subject matter to be searched and/or one or more selected patent documents. The passage and/or documents define the natural language content of the search query 110 which is compared to the natural language content of the set of patent documents 115. Additionally, the search query may optionally include one or more bibliographic criteria restricting the search (such as a priority date criteria limiting the search to patent documents with an earlies priority date in a selected range).

A search query including a natural language passage may be used by a person such as an inventor or a patent attorney to search for potential prior art and establish whether an invention described in the passage is novel and potentially patentable. Such a written description of an invention may be supplemented by one or more user-selected patent documents, which may be patent documents known to be relevant to the invention, such as the results of earlier searches. In contrast, a search query consisting of only one or more patent documents may be used as part of ongoing monitoring to identify any new publications of patent documents relating to a product covered by said one or more patent documents.

In a first stage of the search process, the search query is compared to a set of patent documents 115 using a bi-encoder arrangement based on an embedding model 120, in which a query vector embedding 130 representing the semantic content of the search query 110 is compared to a document vector embedding 135 representing the semantic content of each of the set of patent documents 115.

The set of patent documents 115 is derived from a larger collection of all published patents and patent applications available to the system. It comprises one patent document from each family of patent documents in the larger collection that include one or more members satisfying any bibliographic criteria of the search query (or a machine translation thereof where the only such patent documents in a family are not in a chosen language).

Vector embeddings 130, 135 are mathematical representations of the natural language content of bodies of text, such as the natural language content of the search query 110 or of the patent documents in the searched set 115. They are determined using a specially trained embedding machine learning model 120, which is configured to receive a body of text as an input and to output a vector embedding of that text as an output. The more similar the content of two bodies of text the more similar their vector embeddings, and a measure of the similarity between two texts may therefore be obtained by determining the cosine similarity of two vector embeddings derived therefrom.

Document vector embeddings 135 for each member of the set of patent documents 115 are pre-derived and stored in a database. As the same patent documents may be used in a large number of different searches, pre-deriving their vector embeddings 135 in this manner accelerates the search process.

Unlike conventional bi-encoder machine learning model configurations, the vector embeddings 135 for the set of documents 115 to be searched are not direct vector embeddings of the entire contents of said documents. Instead, the system exploits the specific structure of patent documents—which comprise a plurality of sections separately describing a given invention in different levels of detail—to derive more representative vector embeddings for the set of patent documents 115.

FIG. 1b shows an example of a document vector embedding 135 being derived for a member of the set of patent documents 115.

The patent document 115 is separated into its description 116, its set of claims 117, its abstract 118 and its title 119 (while patent applications often include a section describing the prior art to the invention, for the purposes of the present description this section is largely ignored in the vector calculations). These four sections 116, 117, 118, 119 are each separately input into the embedding model 120 and a respective embedding vector 136, 137, 138, 139 of each section is derived. A weighted average of the vector embedding of the description 136, the vector embedding of the claims 137, the vector embedding of the abstract 138 and the vector embedding of the title 139 is then calculated and used as the vector embedding 135 for that document when calculating its similarity to the search query 110. Such a document vector embedding can more accurately reflect the invention described in the patent document.

In training, the document vector embedding for a patent document is formed as a weighted sum of section embeddings of the claims, abstract, description and optionally title, where the weights are trainable parameters. The embedding model and the section weights are jointly optimized via backpropagation to minimize a loss that penalizes divergence between calculated pairwise similarities and patent-specific similarity labels. Patent-specific labels are derived from a fusion of CPC/IPC proximity metrics (e.g., shared subclasses, shortest path distance in the classification hierarchy) and citation-derived signals (e.g., forward and backward examiner citations in office actions), optionally with jurisdictional normalization. The training data comprises pairs of patent documents with label values in a bounded range. The loss can be implemented as mean squared error or a margin-based contrastive loss, and optimization may employ AdamW with weight decay in the range of 1e−4 to 1e−2.”

The embedding model is trained using training data consisting of a number of patent documents and similarity metrics between pairs of said patent documents derived from the proximity or overlap between international patent classification (IPC) codes and/or cooperative patent classification (CPC) codes of the two documents and/or on any citations of an earlier of the two patent documents against the later of the two patent documents for the purposes of novelty or inventive step in any search reports, examination reports, or other office actions for the latter patent document. In addition to training the internal weights of the model, the training is used to fine-tune the weights of the average of the description, claim set and abstract vector embeddings 136, 137, 138.

The embedding model is section-aware: each input includes a section-type indicator token (e.g., [CLAIMS], [ABSTRACT], [DESCRIPTION], [TITLE]) prepended to the text, and/or a section-specific positional embedding. This conditioning causes the encoder to learn distinct representations per section and improves downstream weighting.

Performing a search using the system shown in FIG. 1a comprises deriving a query vector embedding 130 based on the search query 110, using the embedding model 120.

If the natural language content of the search query 110 consists of only a natural language passage, the query vector embedding 130 is a direct vector embedding of that natural language passage.

Alternatively, if the natural language content of the search query 110 is a single patent document, such as when the system is used to monitor that patent document, the query vector embedding 130 is the document vector embedding for that document, derived as described above as a weighted average of the vector embeddings 136, 137, 138 of its description, claim set and abstract. Such a vector embedding may be retrieved from the database of vector embeddings storing the document vector embeddings 135 of the set of patent documents 115.

Alternatively, if the natural language content of the search query is a plurality of patent documents, the query vector 130 embedding is an average of the document vector embeddings for those patent documents, and if the natural language content of the search query comprises a natural language passage and one or more selected patent documents, the query vector embedding 130 is an average of the vector embedding of the natural language passage and of an average of the document vector embeddings of the one or more selected patent documents.

After the query vector embedding 130 is derived, a first similarity value 140 between the search query 110 and each of the set of patent documents 115 is calculated by calculating the cosine similarity or Euclidean distance (L2), or other appropriate method as will be apparent to a person skilled in the art, between the query vector embedding 130 and the document vector embedding 135 for that patent document 115. The higher the first similarity value 130, the more similar that patent document 115 is to the search query 110. It will be appreciated that in alternative embodiments, a vector search may be performed in which only a first similarity values are only calculated between the search query 110 and some of the set of patent documents 115, for example when performing a vector search using a pre-determined Hierarchical Navigable Small Worlds vector graph of the set of patent documents.

The first similarity threshold is determined adaptively from the distribution of the top-k first similarity values. In one implementation, the threshold is set to a percentile within the top-k values selected based on a dispersion statistic such as interquartile range (IQR), median absolute deviation (MAD), or a variance estimate. For example, when the top-k distribution is multimodal, a knee-point heuristic combined with IQR can place the threshold between modes to preferentially include tightly clustered high-similarity candidates.

After the first similarity threshold is determined, the subset of patent documents with first similarity values above the first similarity threshold are identified as a first subset 150 of the patent documents. These patent documents are candidate search results.

The bi-encoder arrangement that performs the first stage of the method described above is referred to as a patent semantic similarity engine.

After the first subset 150 of patent documents is identified, a second stage of the method is performed in which a cross-encoder model 160 is used to re-rank the first subset 150 by determining second similarity values between each of these patent documents and the search query 110.

As will be detailed hereafter, the cross-encoder model 160 or re-ranker model 160 is a natural language machine learning model configured to receive an input combining the natural language content of the search query 110 and one of the first subset 150 of patent documents and to output a value indicating the similarity between these two texts. Each document in the subsent passes through the cross encoder. Cross encoder models are more computationally intensive than bi-encoder models but are able to produce more accurate similarity values due to interactions between the two texts within the model.

After the second similarity values 170 are determined between the search query 110 and each of the first subset 150 of patent documents, a second similarity threshold is selected based on user inputs, and the patent documents with second similarity values above the second similarity threshold are identified as a second subset 180 of the patent documents defining the search results.

After the second subset 180 of patent documents are identified, the illustrated embodiment uses a large language machine learning model 190 to generate natural language relevance analyses 195 describing the degree of similarity between the search query and each of the second subset 180 of patent documents. In the illustrated example, the large language model 190 is a separate model to the cross encoder model 160, however, in alternative embodiments the cross encoder model may be configured to output both second similarity values and the natural language relevance analyses 195.

Search results comprising the identified second subset of patent documents 180 and their corresponding natural language relevance analyses are then output from the system and/or displayed to a user with a user interface.

The cross-encoder model arrangement that performs the second stage of the method described above is referred to as a patent relevance analysis engine.

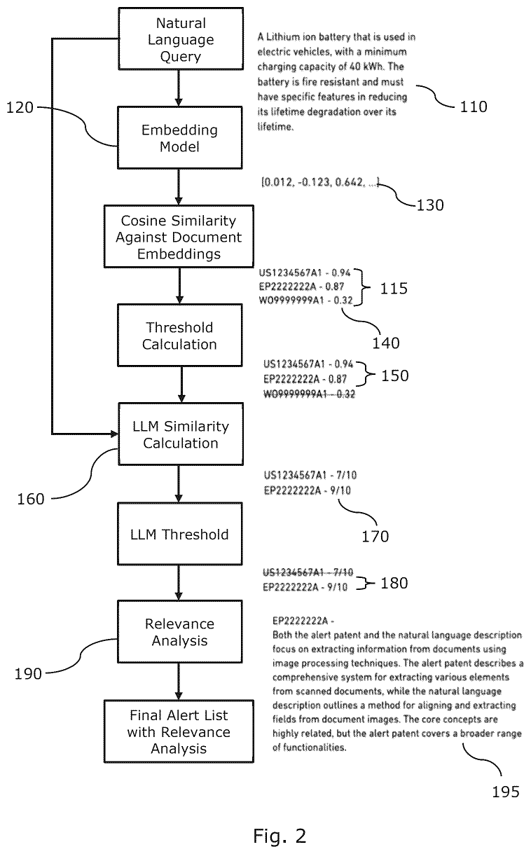

FIG. 2 shows an example of the steps of a search being performed using a system as described above with reference to FIGS. 1a and 1b.

In a first step of the search process a natural language query 110 is obtained. FIG. 2 shows an example of a search query passage consisting of the natural language passage: “A Lithium ion battery that is used in electric vehicles, with a minimum charging capacity of 40 kWh. The battery is fire resistant and must have specific features in reducing its lifetime degradation over its lifetime.”

In a second step of the search process, the embedding model 120 is used to determine a query vector embedding 130 encoding the semantic content of the natural language search query.

In a third step, the first similarity values 140 between the determined query vector 130 and retrieved document vector embeddings 135 for each of the set of patent documents 115 are calculated by calculating the cosine similarities therebetween. FIG. 2 only shows three example cosine similarity values for three patent documents for clarity, but it will appreciated that in practice, the set of patent documents 115 will comprise more than three documents and cosine similarity values 140 will be derived for each.

In a fourth step, an adaptive first similarity threshold is determined and the first subset 150 of patent documents with first similarity values 140 above the threshold are identified. In the illustrated example, patent document WO9999999A1 only has a first similarity value of 0.32, below the first similarity threshold and is not included in the first subset 150 of patent documents. The patent documents in the first subset are considered candidate alerts.

Advantageously, as better shown in FIG. 4, the system and method preferably include a re-ranking. In this re-ranking step, each candidate result is passed into the re-ranker model 160 along with the initial query 110. Thus, the re-ranker uses the original query 110 and the full text of the candidate patent and outputs a new score. This new score is used as a replacement for the embedding calculation score. This is advantageous since the re-ranker model is more powerful and leverages a technique known as “cross-attention”. The result of this re-ranking is a finer (i.e. better) score that the embedding score. This is mostly due to the fact that embedding models must encode the semantic output in a finite data structure which necessarily results in some loss of information and context, while the re-ranker can evaluate each candidate result with the full query context. The reason the embedding model is used is because, unlike the re-ranker process which needs to be run for every search, embeddings can be produced independent of the query for the entire dataset during indexing, which avoids running this process during a user's runtime. This optional re-ranking step uses a machine learning model with an architecture known as a cross-encoder re-ranker. A person skilled in the art will understand that this re-ranking step improves on the quality of the results since one can fetch a larger pool of candidates (but not the entire collection), re-rank those documents and then pass along a smaller but higher quality (i.e. high similarity scores) list of results to the LLM similarity calculation.

In a sixth step, the second similarity value threshold (the LLM threshold) is determined based on user input and the second subset 180 of patent documents with second similarity values 170 above said threshold is identified. In the illustrated example, the second subset 180 consist of only patent document EP2222222A, with a second similarity value of 9/10. The patent documents in the second subset are considered alerts.

In a seventh step, the large language machine learning model 190 is used to derive a relevance analysis natural language description 195 for each patent document in the second subset 180. FIG. 2 shows an example relevance analysis for patent document EP2222222A. It will be appreciated that the illustrated relevance analysis is an example relating to a different search query to the Lithium ion based search query shown in FIG. 2.

In an eighth and final step the list of alert patent documents in the second subset 180 are output to a user, along with their associated relevance analysis passages 195.

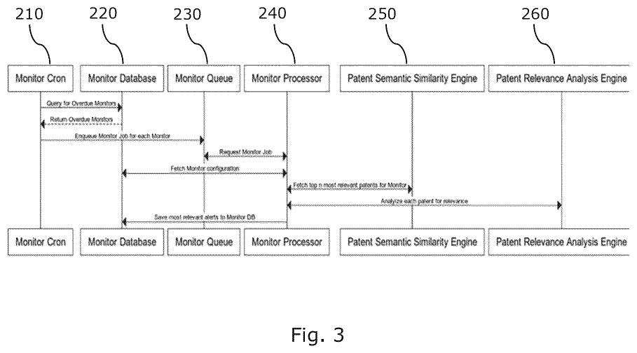

FIG. 3 shows an automated method and system for monitoring patent publications using an embodiment of a searching method as described herein. The system and method allows a user to monitor newly published patents and patent applications for the purposes of discovering infringement or licensing opportunities or simply to stay up-to-date with technological developments in a specific area.

User-configured ‘monitors’ are stored in a monitor database 220, each monitor comprises a search query as described above and an associated frequency with which it is to be performed. Each day, a scheduler, for example a cron service 210, queries the monitor database to retrieve all monitors that are overdue and enqueues a monitor job in a monitor queue 230, a message queue that holds monitor jobs waiting to be processed. The monitor queue 230 allows control over the degree of concurrently when processing monitor workloads in order to avoid overloading specific components of the monitoring system. A monitor processor 240 dequeues monitor jobs from the monitor queue 230 and processes them. When processing a monitor job, the monitor processor 240 retrieves the configured search query from the monitor database 220 and performs a search as described above with reference to FIG. 1a, using a patent semantic similarity engine 250 comprising an embedding model in bi-encoder arrangement to identify a first subset of n most relevant patent documents, and an patent relevance analysis engine 260 comprising a cross-encoder model to analyse the relevance of the first subset of patent documents and identify a second subset thereof, which are stored in the monitor database 220.

Referring to FIG. 4, the system receives a search query potentially including bibliographic criteria (400) and computes a proportion p of the corpus satisfying the criteria (410). If p is at least τ (420), Path A (430) is selected: a preconstructed HNSW index over the entire corpus is used to compute first similarity values and bibliographic filters are applied post hoc. If p is less than τ, Path B (440) is selected: the corpus is prefiltered to a reduced sub-corpus and an HNSW index over that sub-corpus is used to compute first similarity values. In both paths, an adaptive threshold based on dispersion statistics of the top-k similarities selects the first subset (450), after which a cross-encoder model computes second similarity values (460) and the second subset is identified above a second threshold (470).

In one implementation, the encoder is a transformer with 12-24 layers and hidden sizes between 768 and 1024. Maximum input tokens per section are 512-2048, with long-context variants used for claims and description. Training uses batches of 32-128 pairs, a learning rate between 1e−5 and 5e−5, and 1-10 epochs depending on corpus size. The ANN index is incrementally refreshed to account for new publications and embedding model updates.

On an evaluation set comprising examiner-cited prior art pairs and human-validated relevance sets, section-aware weighted embeddings trained with patent-specific labels yielded a mean average precision improvement of 8-15% over uniform section averaging, and the HNSW decision policy reduced candidate retrieval latency by 20-35% at equal recall. Cross-encoder reranking improved nDCG@20 by 10-18% over bi-encoder-only baselines.

It will be appreciated that the illustrated embodiments have been described by way of example only and that variation may be made to the embodiments described above without departing from the scope of the invention as defined by the claims.

1. A method for identifying patent documents similar to a search query, the search query comprising natural language content, the method comprising:
i. determining first similarity values between the natural language content of the search query and patent documents of a set of patent documents by comparing a query vector embedding determined from the natural language content of the search query using an embedding machine learning model to document vector embeddings determined from respective patent documents of the set,
ii. wherein the document vector embedding determined from a respective patent document of the set is a weighted average of separate vector embeddings of the natural language content of a set of one or more claims and of one or more other sections of that patent document, each determined using the embedding machine learning model;
iii. selecting a first subset of the set of patent documents including patent documents with first similarity values above a first similarity threshold;
iv. determining a second similarity value between the natural language content of the search query and each of the first subset of patent documents using a cross-encoder machine learning model; and
v. identifying a second subset of the first subset of patent documents with second similarity values above a second similarity threshold.

2. A method according to claim 1 wherein the natural language content of the search query comprises a natural language passage and/or one or more selected patent documents and wherein the query vector embedding is derived from a vector embedding of the natural language passage determined using the embedding machine learning model and/or from document vector embeddings for each of the one or more selected patent documents.

3. A method according to claim 1 wherein document vector embeddings are derived from each of the set of patent documents and first similarity values are determined between the natural language content of the search query and each of the set of patent documents.

4. A method according to claim 1 further comprising using a large language machine learning model to generate a natural language description of a degree of similarity between the natural language content of the search query and each of the second subset of patent documents.

5. A method according to claim 1 wherein weights are assigned to the separate vector embeddings of the sets of one or more claims and of the one or more other sections of the set of patent documents, and wherein the weights are determined using a machine learning process.

6. A method according to claim 1 wherein the document vector embedding determined from a respective patent document is a weighted average of separate vector embeddings of the natural language content of a title, of an abstract, of a description and of a set of one or more claims of that patent document.

7. A method according to claim 1 wherein the set of patent documents only comprises an individual patent document from each family of patent documents that share a priority claim.

8. A method according to claim 1, comprising either receiving the search query from user inputs and saving the search query to a computer memory or loading the search query from the computer memory.

9. A method according to claim 1, comprising automatically loading a search query from a memory and performing the search based on an amount of time that has lapsed since a search using that query was last performed.

10. A method according to claim 1 wherein the first similarity threshold is determined based on the first similarity values.

11. A method according to claim 7 wherein the first similarity threshold is determined be a fixed percentile of an upper range of the determined first similarity values.

12. A method according to claim 1 wherein the search query further comprises bibliographic criteria, and the set of patent documents is a subset of a larger collection of patent documents that satisfy the bibliographic criteria.

13. A method according to claim 9 wherein the bibliographic criteria includes one or more of filing date criteria, publication date criteria, expiration date criteria, priority claim criteria, current owner criteria, applicant criteria, assignee criteria, licensee criteria, CPC or IPC classification criteria, inventor criteria, legal status, criteria, jurisdiction criteria and legal status criteria.

14. A system for identifying patent documents similar to a search query, the system comprising:
i. one or more processors, and
ii. one or more computer readable storage devices,
iii. the one or more storage devices storing computer instructions which when implemented cause the one or more processors to:
iv. determine first similarity values between the natural language content of the search query and patent documents of a set of patent documents by comparing a query vector embedding determined from the natural language content of the search query using an embedding machine learning model to document vector embeddings determined from respective patent documents of the set,
v. wherein the document vector embedding determined from a respective patent document of the set is a weighted average of separate vector embeddings of the natural language content of a set of one or more claims and of one or more other sections of that patent document, each determined using the embedding model;
vi. select a first subset of the set of patent documents including patent documents with first similarity values above a first similarity threshold;
vii. determine a second similarity value between the natural language content of the search query and each of the first subset of patent documents using a cross-encoder machine learning model; and
viii. identify a second subset of the first subset of patent documents with second similarity values above a second similarity threshold.

15. A method for identifying patent documents similar to a search query, the search query comprising natural language content, the method comprising:
a. generating, by an embedding machine learning model, a document vector embedding for each patent document of a set of patent documents, wherein the document vector embedding for a respective patent document is a weighted sum of separate vector embeddings of a claims section and of one or more other sections selected from an abstract, a description and a title of the patent document, each of the separate vector embeddings being produced by the embedding machine learning model, and wherein weights of the weighted sum are trainable parameters learned via backpropagation using patent-specific similarity labels comprising at least one of CPC or IPC proximity metrics or citation-derived labels;
b. generating a query vector embedding from the natural language content of the search query using the embedding machine learning model;
c. determining first similarity values between the query vector embedding and the document vector embeddings for the set of patent documents;
d. determining a first similarity threshold as an adaptive threshold computed from a dispersion-based statistic of a top-k subset of the first similarity values;
e. selecting a first subset of the set of patent documents including patent documents with first similarity values above the first similarity threshold;
f. determining, for each patent document in the first subset, a second similarity value between the natural language content of the search query and the patent document using a cross-encoder machine learning model configured to receive a concatenation of the natural language content of the search query and at least part of the patent document separated by a separator token and to output a scalar similarity score; and
g. identifying a second subset of the first subset of patent documents with second similarity values above a second similarity threshold.

16. The method of claim 15, wherein the embedding machine learning model is section-aware and receives a section-type indicator for each of the claims, abstract, description and title sections to produce the respective separate vector embeddings.

17. The method of claim 15, further comprising determining a plurality of cross-encoder similarity values for each patent document in the first subset using a plurality of different cross-encoder models trained on different patent-specific similarity labels, and determining the second similarity value by aggregating the plurality of cross-encoder similarity values using at least one of a mean, a median, a maximum, a minimum, or by applying a consensus criterion based on a bounded variance or disagreement threshold.

18. The method of claim 15, wherein the method further comprises applying bibliographic criteria to the set of patent documents and selecting between: (i) using a preconstructed approximate nearest neighbor graph index over the entire corpus to compute the first similarity values and post-filtering search results by the bibliographic criteria; and (ii) pre-filtering the corpus by the bibliographic criteria to form a reduced sub-corpus and using an approximate nearest neighbor graph index over the reduced sub-corpus to compute the first similarity values, wherein the selecting comprises determining a proportion of the corpus satisfying the bibliographic criteria and, if the proportion is at least a threshold, performing (i), and otherwise performing (ii).

19. The method of claim 18, wherein the approximate nearest neighbor graph index comprises a Hierarchical Navigable Small World graph.

20. The method of claim 15, wherein determining the first similarity threshold comprises selecting a percentile within the top-k first similarity values based on a dispersion statistic of the top-k values, the dispersion statistic comprising at least one of an interquartile range, a median absolute deviation, or a variance estimate.

21. The method of claim 15, wherein the natural language content of the search query comprises a natural language passage and one or more selected patent documents, and the query vector embedding is an average of a vector embedding of the passage and one or more document vector embeddings of the selected patent documents, optionally weighted by user-specified importance scores.

22. The method of claim 15, wherein the set of patent documents includes at most one representative document per patent family sharing a priority claim, selected according to at least one of language, jurisdiction, filing date, or a translation quality measure.

23. The method of claim 15, wherein a machine translation of a member of a patent family is used only when no member exists in a chosen language, and inclusion of the translation is gated by a translation quality score satisfying a threshold.

24. The method of claim 15, wherein the weights of the weighted sum and parameters of the embedding machine learning model are jointly optimized during training using a loss that penalizes divergence between calculated similarities and the patent-specific similarity labels.

25. The method of claim 15 further comprising periodically updating the document vector embeddings stored in an index responsive to at least one of publication of new patent documents or an update to the embedding machine learning model.

26. The method of claim 15, further comprising storing the search query in a monitor database together with a frequency and automatically re-running the method upon a lapse of the frequency to identify newly published patent documents meeting the thresholds.

27. The method of claim 15, wherein the cross-encoder machine learning model receives as inputs the search query text and at least a claims section of a candidate patent document separated by a special token.

28. The method of claim 15, further comprising, prior to determining the second similarity value, re-ranking the first subset using a cross-encoder re-ranker that receives as inputs the search query text and candidate patent document text and outputs a re-ranking score, selecting a reduced pool based on the re-ranking score, and determining the second similarity value for the reduced pool.

29. A system for identifying patent documents similar to a search query, the system comprising one or more processors and one or more computer readable storage devices storing instructions which, when executed by the one or more processors, cause the system to perform the method of claim 15.

30. A method for identifying patent documents similar to a search query, the search query comprising natural language content, the method comprising:
a. generating, by an embedding machine learning model, a document vector embedding for each patent document of a set of patent documents, wherein the document vector embedding for a respective patent document is a weighted sum of separate vector embeddings of a claims section and of one or more other sections selected from an abstract, a description and a title of the patent document, each of the separate vector embeddings being produced by the embedding machine learning model, and wherein weights of the weighted sum are trainable parameters learned via backpropagation using patent-specific similarity labels comprising at least one of CPC or IPC proximity metrics or citation-derived labels;
b. generating a query vector embedding from the natural language content of the search query using the embedding machine learning model;
c. determining first similarity values between the query vector embedding and the document vector embeddings for the set of patent documents;
d. determining a first similarity threshold as an adaptive threshold computed from a dispersion-based statistic of a top-k subset of the first similarity values; and
e. selecting a first subset of the set of patent documents including patent documents with first similarity values above the first similarity threshold.
